(19) United States
(12) Patent Application Publication
(10) Pub. No.: US 2011/0088357 A1
(43) Pub. Date: Apr. 21, 2011

(54) METHOD FOR CANNING FOOD MATERIAL HAVING A CYLINDRICAL FORM, AND DEVICE INTENDED TO IMPLEMENT THIS METHOD

(75) Inventor: Daniel Prima, Redene (FR)

(73) Assignee: Sarl Prima Daniel, Redene (FR)

(21) Appl. No.: 12/999,852

(22) PCT Filed: May 13, 2009
(86) PCT No.: PCT/FR2009/000568

§ 371 Date: Dec. 17, 2010

(30) Foreign Application Priority Data
Jun. 18, 2008 (FR) 0803390

(51) Int. Cl. A21C 15/04

(52) U.S. Cl. 53/435

(57) ABSTRACT

A process for the automatic filling of cans with foodstuff that is in the form of a continuous cylinder, characterized in that it includes transporting and inserting a portion of the cylinder into a can that is positioned vertically, and then slicing the cylinder so that it is level with the can.

CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a method for canning food material in the form of a cylinder, in particular in the form of a sausage, and also to a device intended in particular to implement this method.

2. Description of Related Art Including Information Disclosed Under 37 CFR 1.97 and 37 CFR 1.98.

The cylindrical forming of food materials which are intended to be canned, in particular in order to preserve them, means that the product does not have to be altered when whole pieces are used. It is used particularly for fish, making it possible to use salmon or tuna loins, which are fragile foodstuffs. The forming into a sausage provides a finished product having excellent presentation while keeping the starting material intact by virtue of the support provided by the casing of the sausage.

The forming into a sausage of whole, that is to say not ground or minced, food material was developed by the applicant in patent FR 2 811 516. The food material is pressed strongly between two conveyor belts having a trough shape, the internal profile of which is notched, said conveyor belts forming a conveying tunnel. The belts are then introduced by force into a casing, this giving the food material a sausage form.

If these sausages of food material are intended to be canned, they are generally cut and then placed manually into the can. These operations are long and require a workforce, this representing a loss of efficiency.

### BRIEF SUMMARY OF THE INVENTION

The present invention intends to remedy these drawbacks by providing a method and a device for cutting and automatically canning sausages of food material.

To this end, the subject of the present invention is a method for automatically filling cans with food material in the form of a continuous cylinder, characterized in that it includes feeding and inserting part of said cylinder into a can held vertically and then in severing the cylinder level with the can.

### BRIEF DESCRIPTION OF THE DRAWINGS

The invention will be understood more clearly with reference to the appended drawings, in which:

FIG. 1 shows a schematic assembly view of the canning device;

FIG. 2 is a schematic representation of the plate containing the cans and of the system for actuating the sausage severing device; and

FIG. 3 is a detailed schematic representation of the cutting device.

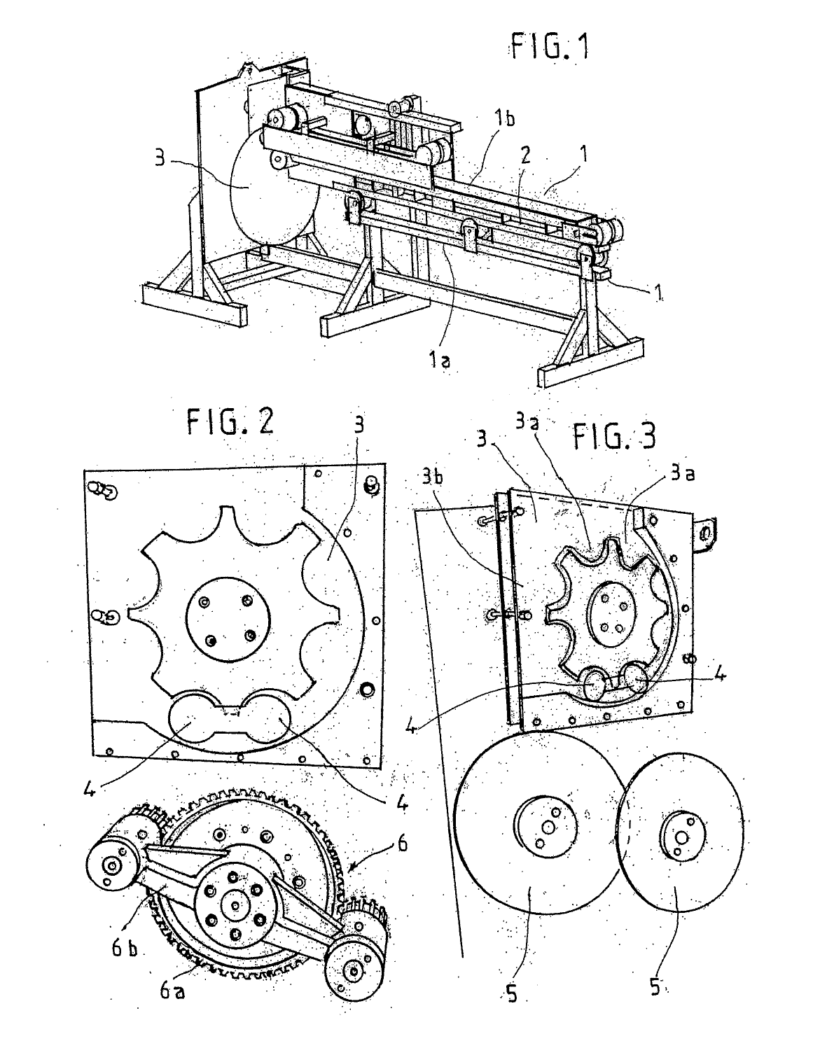

### DETAILED DESCRIPTION OF THE INVENTION

The particular feature of the canning method according to the invention resides in the fact that it enables cans to be filled with food materials having a sausage form. On account of the fact that it is a semi-converted product, its use can be mastered better than raw material.

The canning method according to the invention includes first of all in using sausages of food material, preferably of unconverted, that is to say not minced or ground, starting material and in particular tuna or salmon loins. Since the forming of the food material into a sausage is not part of the invention, it will not be described in more detail.

The sausages of food material are positioned beforehand on a loading table (not shown), which feeds them toward endless conveyors 1. The latter are still positioned in pairs and there are at least two, preferably four, of them so as to increase the filling rate of the cans. The rest of the description will apply to the case in which the device according to the invention includes four conveyors, but this example is in no way limiting.

The conveyors 1 are positioned in pairs, one is placed in a lower position 1a while the other is in an upper position 1b such that they are positioned one facing the other and in parallel. The upper conveyor 1b is shorter than the lower conveyor 1a.

Each conveyor pair 1a and 1b is provided with a conveyor belt in the form of a channel, which partially surrounds the sausage of food material and guides it.

Over the length where each conveyor, the lower conveyor 1a and the upper conveyor 1b, is parallel, the conveyor belts are turned toward one another so as to form a conveying tunnel 2, into which the sausage of food material is fed in order to be canned.

At the outlet from the conveying tunnel 2, once they have been fed, the sausages of food material are located facing a plate 3 which is positioned perpendicularly with respect to the conveyors 1.

On its rear face, this plate 3 has a rotating region 3a, while its front face has a panel 3b facing the conveyors 1. The plate 3 is in a static position when the sausages arrive there via the conveyors 1.

The rotating region 3a is approximately star-shaped, the arms of the star being rounded, corresponding to a semicircle. This rounded form represents cavities for positioning and partially retaining the cans, likewise having a circular form. The cans are finally held by means of the panel 3b, which locks them in a vertical position in order that they face the conveyors 1.

If the cans have an oval, rectangular or square form, the star of the rotating region 3a will have arms having a form matching that of the can. The cavities in the rotating region 3a will correspond in fact to the form of half a can.

Some of these cans, two when there are two pairs of conveyors, are positioned facing two circular orifices 4, which are located in the lower part of the panel 3b of the plate 3, and at the same height with respect to the lower conveyors 1a, so that these cans are brought into contact with the sausages.

The diameter of the orifices 4 corresponds approximately to that of the cans. However, the size and form of these orifices can vary depending on the features of the can that is intended to be housed therein.

Since there are preferably two pairs of conveyors 2, the plate 3 can have at the same time two cans for two sausages of food material, thereby increasing the filling rate of the cans.

Since the lower conveyor 2a is longer than the upper conveyor 2b, the sausage can be moved toward the plate 3, more precisely at the orifices 4, and in particular toward the can positioned there.

The sausage of food material is then cut by means of circular severing blades 5 that form a cutter. There are two of these circular blades 5 and they operate by means of a gearing 6, which is located on their rear face. These blades 5 are located beneath the plate 3 and in an offset manner such that they are superimposed on the panel 3b during their actuation.

The gearing device 6 has a gearwheel 6a on which there is positioned an articulated arm 6b carrying at each of its ends one of the circular blades 5. Once the sausages have been inserted into the can, the gearing device 6 starts up automatically; it then rotates the arm 6b, enabling one of the circular blades 6 to be superimposed on the panel 3b of the plate 3 in order to cut the sausage there. The circular blades 5 are actuated by a centrifugal force.

The circular blades 6, of which there are two, have different diameters, making it possible to adapt to the nature of the food sausage.

Once the cans have been filled with two sectioned sausages, they are moved away by moving a notch in the rotating region 3a of the plate 3, which then positions two new empty cans at the orifices 4, facing the conveyors 1. This movement is performed by a gearing device which rotates the rotating region 3a of the plate 3, the panel 3b for its part being stationary.

The movement of the rotating region 3a of the plate 3 makes it possible to introduce new empty cans in front of the sausages of food material. Each time the rotating region 3a is moved, two new cans are filled with sausage of food material.

Once all the cans present in the rotating region 3a of the plate 3 have been filled with sausage of food material, they are removed and the rotating region 3a is resupplied with new empty cans. This resupplying and emptying device is automatic and connected to the actual canning device, such that the latter can rotate continuously.

The entire canning device for sausages of food material is controlled by an automatic unit, which enables in particular the actuation of the circular blades when the cans are filled, the movement of the rotating region and the arrival of new empty cans to be adjusted.

The device according to the invention limits losses of food material inasmuch as canning takes place before the sausages are severed, and cutting takes place level with the cans by virtue of the panel of the plate covering the cans.

In addition, since the device operates continuously and automatically, it saves on the workforce, thus increasing efficiency. Approximately 200 cans per minute can be canned.

The canning device preferably takes round cans of different diameters; however, it could take cans of different forms inasmuch as the sausages are not cylindrical.

Although the invention has been described with particular implementation means, it comprises any technical equivalents of the means described.

1. A method for automatically filling cans with food material in the form of a continuous cylinder, characterized in that it comprises feeding and inserting part of said cylinder into a can positioned vertically and then in severing the cylinder level with the can.

2. A device for automatically filling cans with food material in the form of a continuous comprising: a loading table and at least two conveyors positioned in pairs in parallel, the lower conveyor being longer than the upper conveyor, each conveyor being provided with a conveyor belt in the region of identical length and forming a feeding tunnel for said cylinder, characterized in that said device is provided with a plate which is positioned vertically and faces the conveyors, said plate enclosing said cans between a rotating region and a panel, said panel being further provided with at least one orifice, which is located at the same level as the lower conveyor and enables a can to be introduced in front of a cylinder, and two circular blades, which are positioned beneath the plate.

3. The automatic filling device of claim 2, characterized in that the rotating region is provided with cavities in the form of half a can.

4. The automatic filling device of claim 2, characterized in that the rotating region is actuated by a gearing, making it possible to move the empty cans toward the orifice.

5. The automatic filling device of claim 2, characterized in that the circular blades are positioned on a gearing device having an articulated arm carried by a gearwheel.

6. The automatic filling device of claim 2, characterized in that the circular blades are superimposed on the panel during their actuation.

7. The automatic filling device of claim 2, characterized in that it is actuated by an automatic unit, making it possible to cut the cylinder of food material after it has been inserted into the can.
